(19) United States
(12) Patent Application Publication
(10) Pub. No.: US 2006/0208700 A1
(43) Pub. Date: Sep. 21, 2006

(54) Rechargeable battery and its fabrication

(76) Inventors: Tae-Yong Kim, Yongin (KR); Jae-Kyung Kim, Yongin (KR); Soo-Seok Choi, Yongin (KR)

Correspondence Address: Robert E. Bushnell, Suite 300, 1522 K Street, N.W., Washington, DC, 20005, US

(21) Appl. No.: 11/374,155

(22) Filed: Mar. 14, 2006

(30) Foreign Application Priority Data
Mar. 21, 2005 (KR) 10-2005-0023207

(51) Int. Cl. H02J 7/00

(52) U.S. Cl. 320/128

(57) ABSTRACT

A rechargeable battery includes an electrode assembly having positive and negative electrodes and a separator interposed therebetween and a case housing the electrode assembly and having an insulating layer arranged on its surface to insulate the case and prevent short-circuits and electrical leakage.

### CLAIM OF PRIORITY

This application makes reference to, incorporates the same herein, and claims all benefits accruing under 35 U.S.C. § 119 from an application for SECONDARY BATTERY AND THE FABRICATION METHOD THEREOF, earlier filed in the Korean Intellectual Property Office on the 21^{st} of March 2005 and there, duly assigned Serial No. 10-2005-0023207.

### BACKGROUND OF THE INVENTION

1. Field of the Invention

The present invention relates to a rechargeable battery and its method of fabrication. More particularly, the present invention relates to a rechargeable battery including a battery case with an improved structure and its method of fabrication.

2. Description of the Related Art

A rechargeable battery is generally distinguished from a primary battery in that it can be repeatedly charged and discharged. A rechargeable battery with low capacity comprises a unit cell, which is used for small portable electronic devices such as mobile phones, laptop computers, and camcorders. On the other hand, a rechargeable battery with high capacity comprises a plurality of unit cells as a pack and is commonly used as a power source for driving a motor of a hybrid electric automobile and the like.

The rechargeable battery is mainly formed in a cylindrical or prismatic shape.

In addition, the rechargeable batteries are connected in series to form a rechargeable battery module with high capacity that can be used for driving a motor of an electric vehicle requiring a large amount of electric power.

The rechargeable battery module generally includes a plurality of rechargeable batteries (hereinafter referred to as unit cells for convenience).

The unit cells respectively include an electrode assembly, which is composed of positive and negative electrodes and a separator interposed therebetween, a case having a space for housing the electrode assembly, a cap assembly combined with the case and sealing it, and positive and negative terminals protruding through the cap assembly and electrically connected with the positive and negative electrodes of the electrode assembly.

Each unit cell, which is generally formed in a prismatic shape, is connected to the rest using a nut that conductively links a positive terminal of one unit cell to a negative terminal of a neighboring one, forming a rechargeable battery module.

Each unit cell internally generates a great deal of heat as it is repeatedly charged and discharged. Accordingly, a rechargeable battery module comprising several or tens of unit cells should be able to easily dissipate the heat generated by the unit cells. The heat dissipation characteristic of a rechargeable battery module has a critical influence on the performance of a battery.

When a battery module cannot properly dissipate heat, the heat generated from unit cells increases the temperature inside the battery, resultantly deteriorating battery performance.

In particular, when the rechargeable battery module is applied to a rechargeable battery with high capacity for driving a motor of an electric vacuum cleaner, an electric scooter, or an automobile (an electric vehicle or a hybrid electric vehicle), it is charged and discharged by a high current and proportionally generates more heat. The heat substantially increases the temperature inside the battery through an internal reaction thereof and has a disadvantageous influence on battery characteristics, deteriorating battery performance.

Therefore, the heat dissipation characteristic in a battery module plays a very important role in fabricating a battery with high capacity.

In general, the case is formed of a metal that is capable of efficiently dissipating heat generated from unit cells, and the metal should have excellent electro-conductivity as well as heat-conductivity.

In addition, cell barriers are mounted between each unit cell to form passage paths through which a coolant can flow. The battery module is formed by connecting threaded negative and positive terminals protruding out of each of the unit cells arranged in series with a nut.

Herein, when the conductors are electrically connected with the cases neighboring each other through a medium of cell barriers, the battery module can have a short-circuit. In addition, when the unit cells have a problem of electrolyte solution leakage, which may electrically connect neighboring unit cells, the unit cells cannot work properly.

Furthermore, when the case that is electrically connected with an electrode assembly at its internal surface is connected not with a terminal of a neighboring unit cell but with other parts such as a case thereof, there is another problem of electrical leakage, resulting in deteriorating performance of the unit cell.

### SUMMARY OF THE INVENTION

The present invention has been made in an effort to provide a rechargeable battery having advantages of improved structural safety and reliability by improving the structure of a case.

According to one embodiment of the present invention, a rechargeable battery is provided including: an electrode assembly including positive and negative electrodes and a separator interposed therebetween; and a case adapted to house the electrode assembly and having an oxide film insulating layer arranged on the surface thereof and either an organic material layer or an inorganic material layer arranged on the oxide film insulating layer.

The oxide film insulating layer preferably includes an anodic oxidation film insulating layer. The anodic oxidation film insulating layer preferably has a thickness ranging from 30 μm to 100 μm: The anodic oxidation film insulating layer preferably includes aluminum oxide. The oxide film insulating layer is preferably arranged on an external surface of the case.

The rechargeable battery is preferably adapted to drive a motor.

According to another embodiment of the present invention, a rechargeable battery is provided including: an electrode assembly including positive and negative electrodes and a separator interposed therebetween; and a case adapted to house the electrode assembly and having an oxide film insulating layer arranged on its surface.

The oxide film insulating layer preferably includes an anodic oxidation film. The anodic oxidation film insulating layer preferably has a thickness ranging from 30 μm to 100 μm. The anodic oxidation film insulating layer preferably includes aluminum oxide. The oxide film insulating layer is preferably arranged on an external surface of the case.

The rechargeable battery is preferably adapted to drive a motor.

According to still another embodiment of the present invention, a method of fabricating a rechargeable battery is provided, the method including: laminating positive and negative electrodes and a separator interposed therebetween to form an electrode assembly; arranging the electrode assembly within a case; forming an insulating layer on the case housing the electrode assembly; and sealing the case housing the electrode assembly.

Forming the insulating layer preferably includes anodizing the case to form an anodic oxidation film insulating layer. Forming the insulating layer preferably additionally includes sealing micropores in the anodic oxidation film insulating layer with an organic material. The method preferably further includes forming the anodic oxidation film insulating layer to have a thickness ranging from 30 μm to 100 μm. The method preferably further includes forming the anodic oxidation film insulating layer by a low temperature sulfuric acid method.

### BRIEF DESCRIPTION OF THE DRAWINGS

A more complete appreciation of the present invention, and many of the attendant advantages thereof will be readily apparent as the present invention becomes better understood by reference to the following detailed description when considered in conjunction with the accompanying drawings in which like reference symbols indicate the same or similar components, wherein:

FIG. 1 is an exploded perspective view of a rechargeable battery according to one embodiment of the present invention.

FIG. 2 is a cross-sectional view of the rechargeable battery of FIG. 1 taken along the line A-A.

FIG. 3 is a perspective view of a rechargeable battery module according to the embodiment of the present invention.

### DETAILED DESCRIPTION OF THE INVENTION

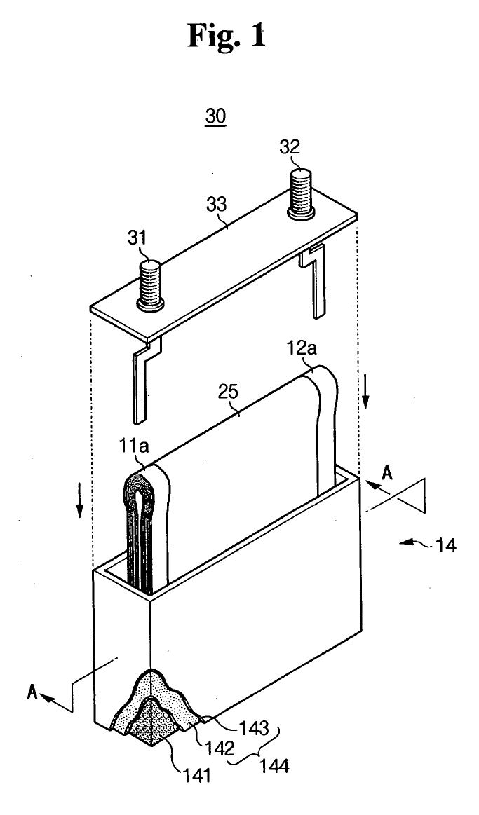

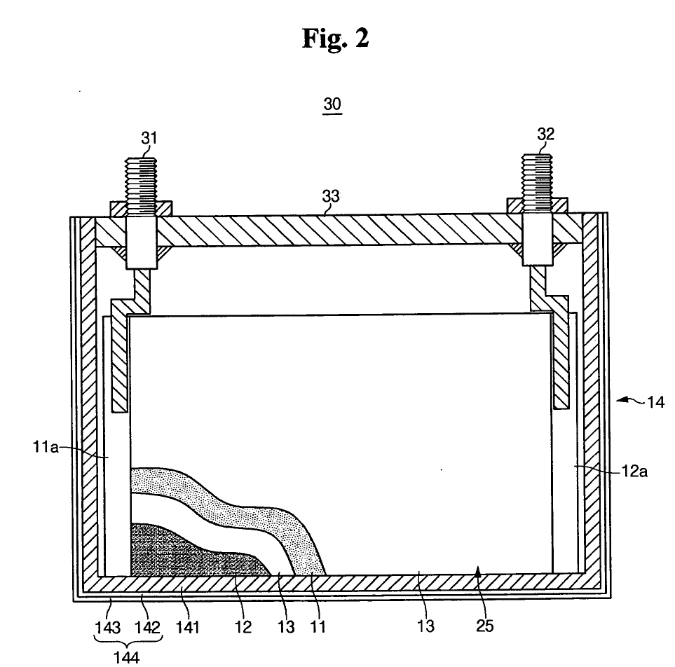

FIG. 1 is a perspective view of a rechargeable battery 30 according to the present invention, and FIG. 2 is a cross-sectional view of the rechargeable battery 30 of FIG. 1 taken along the A-A line.

Referring to the drawings, each unit cell 30 of a high capacity battery module includes an electrode assembly 25 comprising positive and negative electrodes 11 and 12 and a separator 13 interposed therebetween, a case 14 having a space for housing the electrode assembly 25 and an insulating layer 144 on the surface of the body 141 of the case 14, a cap plate 33 joined to the case 14 to close and seal the case 14, and positive and negative terminals 31 and 32 that are electrically respectively connected to the positive and negative electrodes 11 and 12 and that outwardly protrude from the cap plate 33.

The unit cell 30 is fabricated by forming the electrode assembly 25 by stacking the separator 13 and the positive and negative electrodes 11 and 12 attached to each side of the separator 13, forming the insulating layer 144 on the case body 141, and housing the electrode assembly 25 in the case 14 and sealing it with the cap plate 33 including the electrode terminals 31 and 32 that are electrically respectively connected to the positive and negative electrodes 11 and 12.

The positive electrode 11 includes a positive current collector formed of a thin metal foil, for example, an aluminum foil and the like, and a positive active material coated on at least one side thereof. The positive active material mainly includes a lithium-based oxide.

On the other hand, the negative electrode 12 includes a negative current collector formed of a thin metal foil, for example, a copper foil and the like, and a negative active material coated on at least one side thereof. The negative active material mainly includes carbon materials.

In addition, both the positive and negative electrodes 11 and 12 include coated regions formed by coating the current collectors with the active materials, and uncoated regions 11a and 12a where the current collectors are not coated with the active materials.

The uncoated regions 11a and 12a are formed on opposite sides of the positive and negative electrodes 11 and 12 in a lengthwise direction, when they are applied to a high power rechargeable battery. The separator 13 is an insulator interposed between the positive and negative electrodes 11 and 12, and they are stacked and spiral-wound together to form the jellyroll-shaped electrode assembly 25. The electrode assembly 25 can be pressed flat enough to be housed in a prismatic case 14.

The case body 141 is formed of a conductive metal such as aluminum, an aluminum alloy, and nickel-plated steel, and is shaped as a quadrangular prism or another shape having a space for housing the electrode assembly 25. The aluminum alloy can be obtained by alloying aluminum with a metal such as chromium (Cr), magnesium (Mg), titanium (Ti), copper (Cu), iron (Fe), manganese (Mn), silicon (Si), or zinc (Zn), but is not limited thereto. The aluminum alloy can also include A130, A150, A160, and the like, which are commercially available.

The insulating layer 144 includes an anodic oxidation film 142 formed by anodizing the case body 141. The anodic oxidation film 142 can have a thickness ranging from 30 μm to 100 μm. When the anodic oxidation film 142 is less than 30 μm thick, the film is too thin to partially insulate the case, and while the anodic oxidation film 142 is more than 100 μm thick, the film can crack at a high temperature.

In general, an anodic oxidation film is formed on an anode by dipping the anode and a cathode into an electrolytic bath including an acid electrolyte solution, and electrically decomposing them. The anode preferably includes aluminum, and the cathode preferably includes a metal with a lower oxidation potential than that of aluminum. The metal with a lower oxidation potential than that of aluminum preferably includes Zn, Fe, Ni, Cu, Pb, and the like. The acid electrolyte solution can include a sulfuric acid solution, a hydroxylic acid solution, or a mixed acid solution thereof.

According to the embodiment of the present invention, the anodization can include a low temperature sulfuric acid method. The low temperature sulfuric acid method is performed by using the case body 141 as an anode in an aqueous sulfuric acid (H₂SO₄) solution and applying an electric current thereto, so that hydrogen gas is generated at a cathode and oxygen gas is generated at the anode, and the oxygen reacts with the case body 141 made of aluminum to form an oxide film 142.

The low temperature sulfuric acid method is characterized by a lower electrolyte solution temperature which inhibits the film from being dissolved in the electrolyte solution, and by agitating the solution to dissipate the heat generated by the electrolysis. The anodic oxidation film produced in the low temperature sulfuric acid method has high transparency, and excellent dying properties, corrosion resistance, and abrasion resistance. In particular, a hard anodic oxidation film produced in the low temperature sulfuric acid method has excellent insulating performance.

According to the embodiment of the present invention, the case body 141 is formed of aluminum, and the anodic oxidation film 142 comprising aluminum oxide is formed thereon by anodizing the surface of the case body 141 in a low temperature sulfuric acid method. The aluminum oxide layer has excellent insulating properties, to thereby securely insulate the case 14.

However, since the aluminum oxide film 142 formed on the case body 141 has a plurality 6f micropores that can have a negative influence on the insulating properties of the case 14, the holes in the anodic oxidation film 142 should be sealed to form the insulating layer 144.

The sealing treatment is performed by applying an organic material such as oil or a synthetic resin on the aluminum oxide film 142 or by dipping the case body 141 comprising the aluminum oxide film 142 in the aforementioned material. Accordingly, an organic material layer 143 is formed on the aluminum oxide film 142, resulting in a resulting insulating layer 144 with a double-layered structure. The hole-sealing with an organic material is merely exemplary in the present invention, and can vary as long as it can improve the insulating performance of an anodic oxidation film.

The insulating layer 144 can be formed to have a multi-layered structure including an oxide film 142 and an organic material layer or an inorganic material layer formed thereon.

The organic material layer is preferably formed of a resin. The resin can include a fluorinated resin, an epoxy resin, or a mixture thereof. The inorganic material layer can be formed by slurry-coating a powdered inorganic material. The inorganic material can include aluminum oxide and the like.

Then, the terminals 31 and 32 that outwardly protrude from the cap plate 33 are electrically connected to the electrode assembly 25, and the electrode assembly is placed within the case 14 with the insulating layer 144 thereon. The cap plate 33 is then joined to the case 14 and seals it to form a unit cell 30.

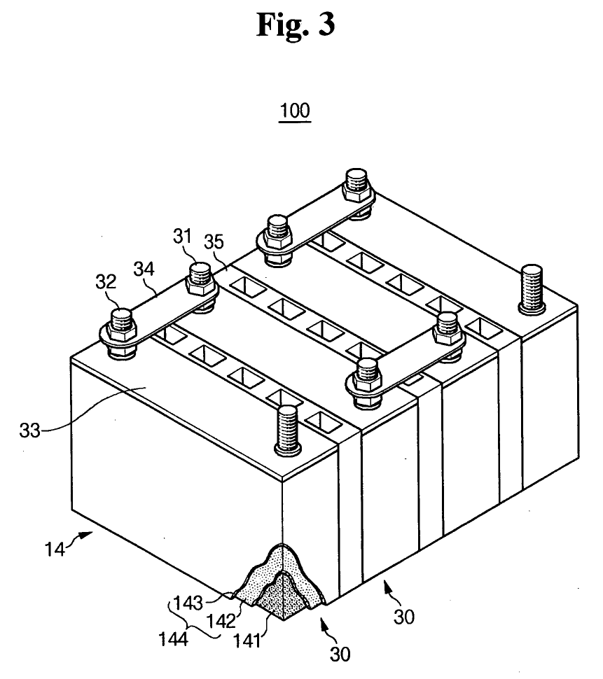

FIG. 3 is a perspective view of a battery module 100 according to an embodiment of the present invention. Referring to the drawing, a plurality of unit cells 30 are arranged in series, and then cell barriers 35 are mounted between the unit cells 30 to form passages through which a coolant can flow.

A positive terminal 31 of a unit cell 30 is electrically connected to a negative terminal 32 of an adjacent unit cell through a connector 34, and the negative terminal 32 of said unit cell 30 is electrically connected to a positive terminal 31 of another adjacent unit cell 30 through another connector 34.

Accordingly, a plurality of unit cells 30 are electrically connected together through connectors 34 in series. Since each unit cell 30 must be electrically insulated except for the terminals 31 and 32 and the connectors 34, the case 14 of each unit cell 30 needs the insulating layer 144 on the surface thereof.

The insulating layer 144 can include only an anodic oxidation film 142 formed by anodizing the case, or the anodic oxidation film 142 and an organic material layer or an inorganic material layer 143 additionally formed on the anodic oxidation film 142.

The anodic oxidation film 142 can be formed of aluminum oxide. In other words, the case 14 formed of aluminum is anodized by a low temperature sulfuric acid method, forming an anodic oxidation film 142 comprising aluminum oxide (Al₂O₃). The aluminum oxide layer has an excellent insulating characteristic, thereby securing the insulation of the case.

However, the anodic oxidation film 142 has micropores, which can have a negative influence on the insulating performance of the case. Accordingly, they should be filled with oil or an organic material, forming an organic material layer 143 on the anodic oxidation film 142. The organic material layer 143 is formed by coating oil or a synthetic resin on the anodic oxidation film 142 or dipping the case 14 into the oil or synthetic resin.

The anodic oxidation film 142 can have an inorganic material layer as well as the organic material layer 143. Furthermore, the insulating layer is illustrated to be formed on only the external surface of the case body 141, but the internal surface thereof can also be insulated in the same method as used on the external surface.

According to the embodiment of the present invention, a case 14 of a unit cell has an insulating layer 144 on the external surface of the case body 141, and when the case is attached to another neighboring case through metal cell barriers 35, the case can be excellently insulated. In addition, if an electrolyte solution leaks during the repeated charges and discharges, the insulating layer 144 can cut off an electric current flow, preventing electrical leakage and a short-circuit.

Therefore, since the case with an insulating layer on its surface can prevent electrical leakage and a short-circuit of a rechargeable battery module, which can occur when the case contacts an external conductor, the case can improve structural safety and reliability of the rechargeable battery module.

Furthermore, the rechargeable battery module can be used as a power source for driving a motor of electric devices such as a Hybrid Electric Vehicle (HEV), an Electric Vehicle (EV), a cordless vacuum cleaner, a motorbike, an electric scooter, and the like.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A rechargeable battery, comprising:
an electrode assembly including positive and negative electrodes and a separator interposed therebetween; and
a case adapted to house the electrode assembly and having an oxide film insulating layer arranged on the surface thereof and either an organic material layer or an inorganic material layer arranged on the oxide film insulating layer.

2. The rechargeable battery of claim 1, wherein the oxide film insulating layer comprises an anodic oxidation film insulating layer.

3. The rechargeable battery of claim 2, wherein the anodic oxidation film insulating layer has a thickness ranging from 30 μm to 100 μm.

4. The rechargeable battery of claim 2, wherein the anodic oxidation film insulating layer comprises aluminum oxide.

5. The rechargeable battery of claim 1, wherein the oxide film insulating layer is arranged on an external surface of the case.

6. The rechargeable battery of claim 1, wherein the rechargeable battery is adapted to drive a motor.

7. A rechargeable battery, comprising:
an electrode assembly including positive and negative electrodes and a separator interposed therebetween; and
a case adapted to house the electrode assembly and having an oxide film insulating layer arranged on its surface.

8. The rechargeable battery of claim 7, wherein the oxide film insulating layer comprises an anodic oxidation film.

9. The rechargeable battery of claim 8, wherein the anodic oxidation film insulating layer has a thickness ranging from 30 μm to 100 μm.

10. The rechargeable battery of claim 8, wherein the anodic oxidation film insulating layer comprises aluminum oxide.

11. The rechargeable battery of claim 7, wherein the oxide film insulating layer is arranged on an external surface of the case.

12. The rechargeable battery of claim 7, wherein the rechargeable battery is adapted to drive a motor.

13. A method of fabricating a rechargeable battery, the method comprising:
laminating positive and negative electrodes and a separator interposed therebetween to form an electrode assembly;
arranging the electrode assembly within a case;
forming an insulating layer on the case housing the electrode assembly; and
sealing the case housing the electrode assembly.

14. The method of claim 13, wherein forming the insulating layer comprises anodizing the case to form an anodic oxidation film insulating layer.

15. The method of claim 14, wherein forming the insulating layer additionally comprises sealing micropores in the anodic oxidation film insulating layer with an organic material.

16. The method of claim 14, further comprising forming the anodic oxidation film insulating layer to have a thickness ranging from 30 μm to 100 μm.

17. The method of claim 14, further comprising forming the anodic oxidation film insulating layer by a low temperature sulfuric acid method.
